(19) United States
(12) Patent Application Publication
(10) Pub. No.: US 2015/0357123 A1
(43) Pub. Date: Dec. 10, 2015

(54) SERIES/PARALLEL MIXED MODULE STRUCTURE OF DYE-SENSITIZED SOLAR CELL AND METHOD OF MANUFACTURING THE SAME

(71) Applicant: HYUNDAI MOTOR COMPANY, Seoul (KR)

(72) Inventors: Eun Yeong LEE, Seoul (KR); Hae Yoon JUNG, Seoul (KR); Sang Hak KIM, Seoul (KR); Mi Yeon SONG, Seoul (KR); Kyoung Jin JEONG, Seoul (KR)

(21) Appl. No.: 14/569,581

(22) Filed: Dec. 12, 2014

(30) Foreign Application Priority Data
Jun. 10, 2014 (KR) 10-2014-0070361

(51) Int. Cl. H01G 9/20

(52) U.S. Cl. CPC H01G 9/2081

(57) ABSTRACT

A dye-sensitized solar cell (DSSC) module includes sub-modules connected in parallel to each other on the same substrate. Each of the sub-modules includes a plurality of cells which have the same upper and lower structures and are connected in series to each other via a conductive grid. The conductive grid connects upper and lower substrates to each other.

### CROSS-REFERENCE TO RELATED APPLICATION

This application claims under 35 U.S.C. §119(a) the benefit of priority to Korean Patent Application No. 10-2014-0070361 filed on Jun. 10, 2014, the entire contents of which are incorporated herein by reference.

### TECHNICAL FIELD

The present disclosure relates to a module of a dye-sensitized solar cell by connecting unit cells in series and/or in parallel and a method of manufacturing the same.

### BACKGROUND

A dye-sensitized solar cell (DSSC) was developed to provide a number of advantages, such as low manufacturing cost as compared to an existing silicon solar cell, high energy conversion efficiency, and a transparent and flexible cell, thus the DSSC can be used in various application fields.

The DSSC includes a photoelectrode having dye molecules that generate electron-hole pairs and a semiconductor layer that transfers the generated electrons. An electrolyte replenishes the dye molecules with the electrons. A counter electrode is coated with a platinum layer serving as a catalyst for an oxidation-reduction reaction of an electrolyte solution. If light is incident on the DSSC, the dye which absorbs the light is in an excited state, so that the electrons move to a conduction band of the semiconductor layer, and the conducted electrons flow along the electrode to an external circuit, thus transferring electrical energy in a low energy state. In such a state, the electrons move to the counter electrode. Then, the dye receives the electrons, corresponding to the number of the electrons transferred to the semiconductor layer, from the electrolyte solution, so that the dye returns to its original state. The electrolyte serves to receive the electrons from the counter electrode by an oxidation-reduction reaction, and then to transfer the electrons to the dye.

The photoelectrode serving as a cathode of the cell includes the semiconductor layer, such as titanium dioxide TiO₂. The dye, which absorbs a visible range of light and generates the electron-hole pairs, is absorbed onto a surface of the photoelectrode. The electrolyte for supplying the electrons to the dye is composed of oxidation-reduction species, such as I⁻/I₃. Lil, Nal, alkyl ammonium iodide, imidazolium iodide, etc. are used as a source of I⁻ ions, and I₃⁻ ions are produced by dissolving I₂ in a solvent. The counter electrode is composed of platinum, etc. and serves as the catalyst for the ion oxidation-reduction reaction, thus providing the electrons to the ions contained in the electrolyte via the oxidation-reduction reaction on the surface.

The dye-sensitized solar cell is manufactured as follows; the minimum units referred to as unit cells are electrically connected to each other and packaged to make modules. Then, the modules are combined with each other to form an array. Thus, it is impossible for the unit cells to produce a current and a voltage sufficient to use at home or in industry. The modules manufactured by connecting the unit cells to each other are classified into, a Z-serial module, a monolithic-serial module, and a W-serial module.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with prior art.

In one aspect, the present disclosure provides a module structure, in which a V-I combination is diversified in one solar cell module unlike a simple series module, and upper and lower structures between connected cells are identical to each other, thus achieving a uniform cell transmittance. An additional area for a conductive grid is not required in the module structure of the present disclosure, thus maximizing an effective area and increasing an aesthetical effect.

In an exemplary embodiment of the present inventive concept, a dye-sensitized solar cell module includes sub-modules connected in parallel to each other in the same substrate. Each of the sub-modules includes a plurality of cells which have the same upper and lower structures and are connected in series to each other via a conductive grid. The conductive grid connects upper and lower substrates to each other.

Each of the cells constituting each of the sub-modules may have the same upper and lower structures.

A portion to which two or more adjacent sub-modules are connected may include the conductive grid on either of a photoelectrode located at an upper position or a counter electrode located at a lower position, and may include a separated structure of a transparent electrode on a remaining one. The portion to which the two or more sub-modules are connected may include the conductive grid on only either of the upper and lower substrates.

In another exemplary embodiment of the present inventive concept, a method of manufacturing a dye-sensitized solar cell module includes applying a conductive grid to each of upper and lower substrates of the module. A conductive grid is eliminated from an anode or cathode side of a portion to which a sub-module is connected. The upper and lower substrates are joined together, upper and lower conductive grids except the connected portion of the sub-module overlap each other to render the cells in the sub-module to be connected in series to each other. It is possible to manufacture the dye-sensitized solar cell module, in which the portion where the two or more adjacent sub-modules are connected to each other has a conductive grid on either of a photoelectrode located at an upper position or a counter electrode located at a lower position, and a separated structure of a transparent electrode is formed on a remaining one.

The module structure of the present disclosure has the following effects:

First, the upper and lower structures of the adjacent cells connected in series are identical to each other, so that the respective cells have the same transmittance, thus ensuring visual stability.

Second, a portion of the conductive grid in a series module structure can be simply eliminated where all the cells are connected to each other in series, thus it is possible to acquire a parallel structure.

Third, an additional grid area is not required, so that it is possible to maximize the effective area.

Other aspects and exemplary embodiments of the inventive concept are discussed infra.

### BRIEF DESCRIPTION OF THE DRAWINGS

The above and other features of the present inventive concept will now be described in detail with reference to certain exemplary embodiments thereof illustrated the accompanying drawings which are given hereinbelow by way of illustration only, and thus are not limitative of the present inventive concept.

FIG. 1 is a schematic view showing a state in which a plurality of sub-modules, composed of cells connected in series, are connected in parallel to each other on the same substrate.

FIG. 2 is a schematic view showing a case in which upper and lower substrates of a module have the same length.

FIG. 3 is a schematic view showing a case in which the sub-modules are connected in parallel to each other in which cathodes are connected to each other within a module, and anodes are connected to each other via a leading wire at an outer portion.It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that present description is not intended to limit the invention to those exemplary embodiments. On the contrary, the inventive concept is intended to cover not only the exemplary embodiments, but also various alternatives, modifications, equivalents, and other embodiments, which may be included within the spirit and scope of the invention as defined by the appended claims.

The present disclosure provides a dye-sensitized solar cell (DSSC) module having identical upper and lower structures in which sub-modules composed of a plurality of cells connected in series are connected in parallel to each other in the same substrate via a conductive grid connecting upper and lower substrates to each other.

Further, in the DSSC module according to the present disclosure, two or more adjacent sub-modules are connected to each other at a portion, a conductive grid is provided on a photoelectrode located at an upper side of the module or a counter electrode located at a lower side of the module, and a separation structure of a transparent electrode is formed on an opposite side of the photoelectrode or the counter electrode that is providing the conductive grid.

In addition, the present disclosure provides a module, in which two or more sub-modules are connected to each other in a portion, the conductive grid is formed on only one of upper and lower substrates, and provides a method of manufacturing the module.

The portion where two or more sub-modules are connected to each other may be separated by cutting a transparent electrode of either of the upper and lower substrates where no conductive grid is formed.

The conductive grid may be formed by sintering a metal paste, for example, a silver paste, or formed by inserting a conductive ribbon or wire.

An insulator partition 40 for separating cells from each other may contain one or more kinds, which are selected from the group consisting of a photo-curable epoxy, a thermal-curable epoxy, photo-curable silicon, thermal-curable silicon, and a thermal-plastic polymer.

The two or more sub-modules may be connected in parallel to each other via a leading wire integrated or joined with the conductive grid and an external wire coupled to another electrode through outside the module.

The present disclosure may include the two or more sub-modules in which cathodes thereof provided on both ends of the sub-modules do not protrude to an outside because the upper and lower substrates of the module have the same length.

A manufacturing method of the DSSC module according to the present disclosure is as follows:

The conductive grid is applied to each of the upper and lower substrates of the module, and the conductive grid is eliminated from an anode or cathode side of a portion to which the two or more sub-modules are connected. The upper and lower substrates are joined together, and upper and lower conductive grids except the connected portion of the sub-modules overlapping each other to render the cells in the sub-modules. Thereby, the dye-sensitized solar cell sub-module, in which the portion where the two or more adjacent sub-modules are connected to each other, has the conductive grid on either the photoelectrode disposed at an upper side of the module or the counter electrode disposed at a lower side of the module. Then, a separated structure of a transparent electrode is formed on a remaining side of the module. The separation of the transparent electrode may be performed by a scribing method using laser beams or a chemical etching method (e.g. a method of reducing the transparent electrode of conductive oxide using hydrochloric acid).

The module structure of the present disclosure is as follows:

First, the upper and lower structures of adjacent cells connected in series are identical to each other, so that the respective cells have the same transmittance, thus ensuring visual stability.

Second, simply by eliminating a portion of the conductive grid in the series module structure where all the cells are connected to each other in series, it is possible to acquire a parallel structure.

Third, the additional grid area is not required, so that it is possible to maximize an effective area.

Hereinafter, the present disclosure will be described in detail with reference to the accompanying drawings.

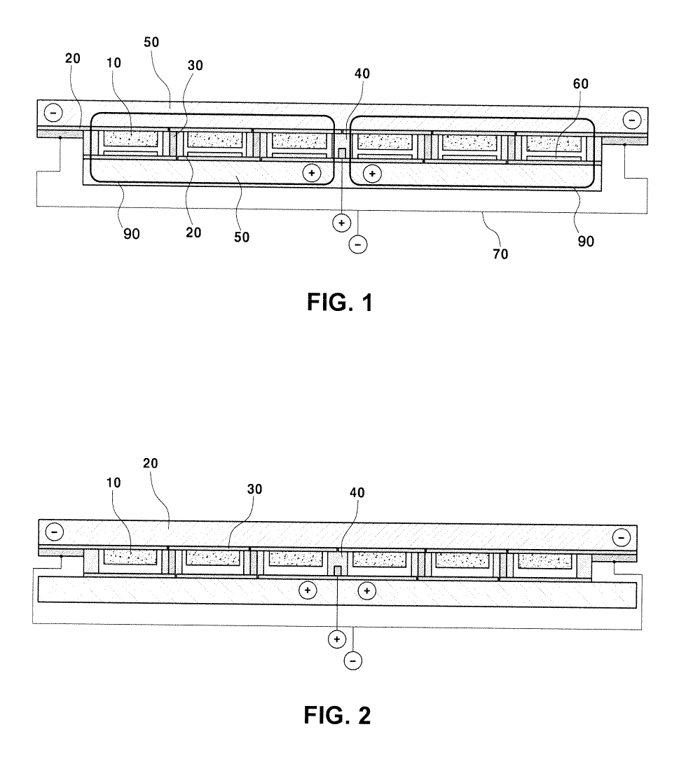

As shown in FIG. 1, a plurality of sub-modules 90, composed of cells connected in series to each other, are connected in parallel to each other in the same substrate.

Among the cells connected in series to each other, a photoelectrode 10 of one cell and a counter electrode 60of a neighboring cell are connected to each other via a conductive grid 30 connecting upper and lower substrates 50 to each other. Cathodes (+) or anodes (−) of the adjacent cells are separated from each other by cutting a transparent electrode 20. That is, connection may be performed in the order of arrangement, that is a first cell (photoelectrode 10-counter electrode 60), a second cell (photoelectrode 10-counter electrode 60), and so on from the left most to the right most or vice versa. The two or more sub-modules 90 may be connected in parallel to each other via a leading wire (not shown) integrated or joined with the conductive grid and an external wire 70 coupled to another electrode through outside the modules 90.

Each sub-module has the same number of cells. The sub-modules are connected in parallel to each other via the transparent electrode 20 or a collector electrode between the anodes.

The opposite electrode may be connected by a wire, which is disposed outside of the module, joined to the cathode.

Further, an anode terminal (not shown) may be formed via the wire connection to the conductive grid 30 of the anode of the parallel connection.

As shown in FIG. 2, according to a module structure of the present disclosure, the upper and lower substrates 50 of a module have the same length, so that cathodes provided on both ends do not protrude to outside.

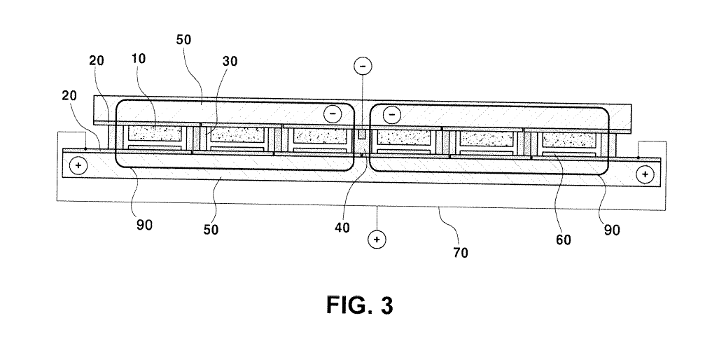

As shown in FIG. 3, according to a module structure of the present disclosure, sub-modules 90 are connected in parallel such that cathodes are connected to each other within a module. The anodes are connected to each other by the leading wire disposed outside of the module. For example, connection may be performed in the order of arrangement, that is a first cell (counter electrode 60-photoelectrode 10), a second cell (counter electrode 60-photoelectrode 10), and so on from the left most to the right most or vice versa.

The inventive concept has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

What is claimed is:

1. A dye-sensitized solar cell (DSSC) module comprising:
sub-modules connected in parallel to each other on the same substrate, each of the sub-modules including a plurality of cells which have the same upper and lower structures and are connected in series to each other via a conductive grid, the conductive grid connecting upper and lower substrates to each other.

2. The module of claim 1, wherein each of the cells in the sub-modules has the same upper and lower structures.

3. The module of claim 1, wherein a portion to which two or more adjacent sub-modules are connected comprises the conductive grid on either of a photoelectrode disposed at an upper side of the DSSC module or a counter electrode disposed at a lower side of the DSSC module, and comprises a transparent electrode that is separately disposed on a remaining side of the DSSC module.

4. The module of claim 3, wherein the portion to which the two or more sub-modules are connected comprises the conductive grid on either of the upper and lower substrates.

5. The module of claim 1, wherein an end to which an adjacent DSSC module is connected to the DSSC module comprises the conductive grid on either of the upper and lower substrates.

6. The module of claim 3, wherein the portion to which the two or more sub-modules are connected is separated and insulated by cutting a transparent electrode provided on a portion of the upper and lower substrates where no conductive grid is formed.

7. The module of claim 2, wherein the conductive grid is formed by sintering a metal paste or by inserting a conductive ribbon or a wire.

8. The module of claim 1, further comprising:
an insulator partition for separating the cells from each other comprising at least one material selected from the group consisting of photo-curable epoxy, thermal-curable epoxy, photo-curable silicon, thermal-curable silicon, and thermal-plastic polymer.

9. The module of claim 2, wherein the two sub-modules are connected in parallel to each other via a leading wire integrated or joined with the conductive grid and an external wire coupled to an opposite electrode in an outside of the DSSC module.

10. The module of claim 1, wherein the upper and lower substrates of the DSSC module have the same length, and cathodes provided on both ends do not protrude to an outside of the DSSC module.

11. The module of claim 3, wherein the connection of the sub-modules may be performed in the order of arrangement.

12. The module of claim 11, wherein the arrangement includes the photoelectrode and the counter electrode.

13. A method of manufacturing a dye-sensitized solar cell (DSSC) module, the method comprising steps of:
applying a conductive grid to each of upper and lower substrates of the DSSC module, in which the conductive grid is separated from an anode or cathode side of a portion to which a sub-module is connected; and
joining the upper and lower substrates together, in which upper and lower conductive grids except the connected portion of the sub-module overlap each other to connect the cells in series to each other in the sub-module,
wherein the portion where the two or more adjacent sub-modules are connected to each other has the conductive grid on either of a photoelectrode disposed at an upper side of the DSSC module or a counter electrode disposed at a lower side of the DSSC module, and a separated structure of a transparent electrode is formed on a remaining one.

14. The method of claim 13, wherein the separation of the transparent electrode is performed by scribing using laser beams or by chemical etching.
